(19) United States
(12) Patent Application Publication
(10) Pub. No.: US 2008/0126609 A1
(43) Pub. Date: May 29, 2008

(54) Method for improved efficiency and data alignment in data communications protocol

(75) Inventors: Robert James, San Jose, CA (US); David Carr, Nepean (CA)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Integrated Device Technology, Inc.

(21) Appl. No.: 11/521,711

(22) Filed: Sep. 14, 2006

(51) Int. Cl. G06F 3/00

(52) U.S. Cl. 710/30

(57) ABSTRACT

A method for improving the speed and efficiency of communicating between two components on a printed circuit board is shown. According to the method, the data in the data frames being transmitted between the components is aligned with the bus width of the receiving component so that less processing time will be expended aligning the transmitted in data for the receiving component. In some embodiments, the data is aligned by placing the checksum in a position in the data frame to be transmitted before the data in the data frame.

### CROSS REFERENCE TO RELATED APPLICATIONS

This application relates to the following co-pending, commonly owned applications: “Method for Deterministic Timed Transfer Of Data With Memory Using a Serial Interface” having attorney docket number 9145.0029-00 and “Programmable Interface for Single and Multiple Host Use” with attorney docket number 9145.0031-00, both of which are incorporated in their entirety by reference.

### DESCRIPTION OF THE INVENTION

1. Field of the Invention

The present invention relates to integrated circuits, and in particular, to communication between integrated circuits.

2. Discussion of Related Art

Modern networking systems allow users to obtain information from multiple data sources. These data sources may include, for example, publicly accessible web pages on the Internet as well as privately maintained and controlled databases. Users may access data from the data sources by entering certain identifying information. For example, a user on the Internet may access data on a website by entering the domain name of the website, where the domain name serves as the identifying information. Similarly, a user of a corporate database may access personnel data about a company employee by entering the last name of the employee, where the last name serves as identifying information. In some instances, a network search engine (“NSE”) of a router or switch may facilitate the process of looking-up the location of the requested data.

FIG. 1a shows an exemplary embodiment of a router with an NSE. The router may receive communications from a network and provide this information to a first integrated circuit (“IC”), such as an application-specific IC (“ASIC”). The ASIC then passes the identifying information to the NSE to determine the location in the memory of the requested data. After determining the location of the data, the NSE may request that the memory provide the requested data to the ASIC while also informing the ASIC that the requested data is being sent by the memory. In many networking systems, the NSE, which may also be implemented using an IC, is mounted to the same printed circuit board (“PCB”) as the ASIC with the traces of the PCB connecting the two components. Although some networking systems may substitute a network processing unit (“NPU”) or a field programmable gate array (“FPGA”) for the ASIC in this description, the roles of the respective components remain the same. Thus, in some networking systems, the NPU or FPGA may accept communications from the network and provide the identifying information to the NSE, which may facilitate delivering the requested data to the NPU or FPGA.

In some networking systems, communication between the NSE and the ASIC occurs using a parallel bus architecture on a printed circuit board. Initially, bi-directional parallel buses were used in which an IC used the same pins to both send and receive information. As data rates between the NSE and ASIC increased, networking systems began to be implemented using uni-directional parallel buses in which the components used each pin to either send or receive data, but not both. To accommodate the amount of data being transmitted between the ASIC and the NSE, some current networking systems use an 80-bit bus on the PCB to connect the ASIC and NSE.

Issues have arisen, however, with the parallel bus architecture for connecting the ASIC and the NSE. For example, using a large bus complicates the design and layout process of the PCB. Additionally, increased processing and communication speeds have exposed other limitations with the parallel bus architecture. For example, the data transmitted by a parallel bus should be synchronized, but as communication speeds have increased, the ability to synchronize data transmitted on a parallel bus has become increasingly more difficult. Additionally, ground-bounce may occur when large numbers of data lines in a parallel bus switch from a logical one to a logical zero. Moreover, a parallel bus may consume a large number of pins on the ASIC and the NSE. Further, a parallel bus may require the NSE to be placed very close to the ASIC. But because both the ASIC and NSE may be large, complex ICs, thermal dissipation issues may result in hot spots occurring that may complicate proper cooling of the components on the PCB. A wide, high-speed parallel bus may also make supporting NSEs on plug-in modules difficult or impossible.

In response to the issues posed by using a large parallel bus, some networking devices connect the ASIC and NSE with a serial bus. Further, the networking device may a use a serializer-deserializer (“SERDES”) to allow one or both of the ASIC and NSE to continue to use a parallel interface to communicate with the other over the serial bus. For example, when the ASIC communicates with the NSE, a SERDES may convert the parallel output from the ASIC to a serial data stream to be transmitted to the NSE over a serial data bus. Another SERDES may receive this serial transmission and convert it to a parallel data stream to be processed by the NSE. As a result, instead of transmitting data over an 80-bit parallel bus at 250 MHz Double Data Rate (40 Gbps), networking devices may transmit data over 8 serial lanes operating at 6.25 Gbps. Despite this increase in data transmission rates as compared to systems using a parallel bus architecture, increasing clock speeds and data transmission rates may require developers of networking devices to seek additional methods for increasing the transmission rates between the ASIC and the NSE.

### SUMMARY

In accordance with the invention, a method for transmitting a data frame from a first component to a second component is disclosed, where the second component may have a data bus width for receiving data. The method may include the steps of identifying a set of data packets containing data bits to be transmitted from the first component to the second component, where the first component and the second component are connected to one printed circuit board; calculating a check-sum as a function of the data bits in the set of data packets to be transmitted; constructing the data frame to be transmitted, where the data frame has at least one packet containing header data, at least one packet containing the check-sum, and the set of data packets containing data bits; and transmitting the data frame to the second component so that the data bits in the set of data packets are correctly aligned to the data bus width of the second component.

These and other embodiments of the invention are further discussed below with respect to the following figures.

### BRIEF DESCRIPTION OF THE DRAWINGS

FIG. 1a shows an exemplary system of a router with a network search engine.

FIG. 1b shows an exemplary block diagram of a circuit capable of implementing the invention.

FIG. 2 shows an exemplary process of improving the efficiency of communication between components according to the present invention.

FIG. 3a illustrates an exemplary embodiment of a data frame that is constructed according to the invention.

FIG. 3b illustrates an example of a prior art data frame.

FIGS. 4a-4c show an embodiment in which a serial connection exists between the components.

### DETAILED DESCRIPTION

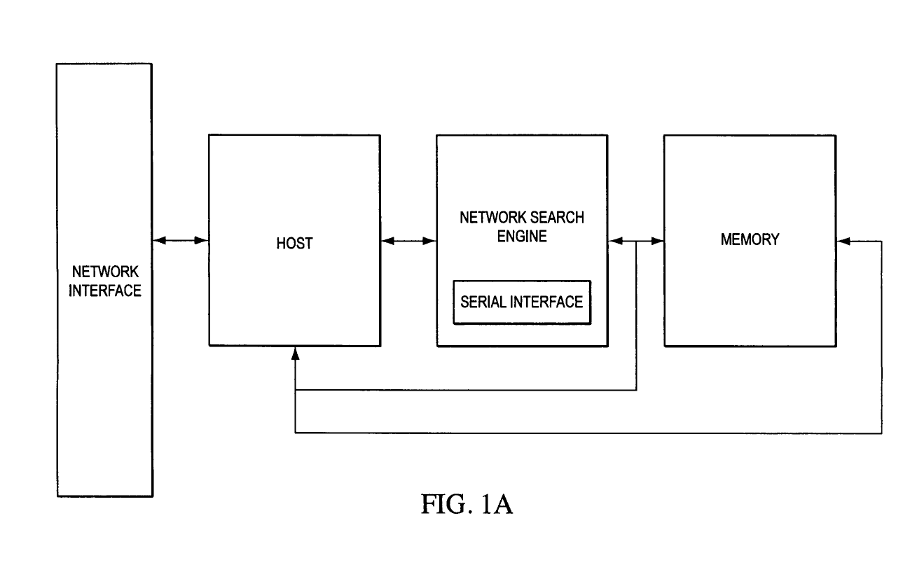

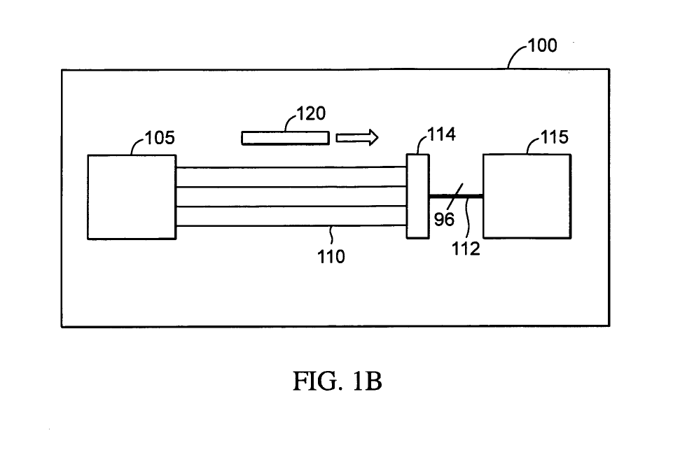

FIG. 1b shows an exemplary block diagram of a circuit capable of implementing the invention. As shown in FIG. 1b, ASIC 105 may be sending data frame 120 over serial bus 110 to NSE 115, where both ASIC 105 and NSE 115 are coupled to PCB 100. Shim component 114 may convert the serial data sent by ASIC 105 so that it may be received by NSE 115 over parallel bus 112. In some embodiments, the parallel interface may correspond to physical pins on receiving component 115. In some embodiments, shim 114 may be integrated into receiving component 115. Many different situations may cause ASIC 105 to send data frame 120 to NSE 115. For example, ASIC 105 may be used to control the operation of PCB 100, which may be a component of a router on a network. PCB 100 may receive a request for a web page on the Internet, the request containing identifying information for the webpage, such as a uniform resource locator (“URL”). To resolve this request, ASIC 105 may compose data frame 120, which may include the identifying information received by PCB 100, and send data frame 120 to NSE 115. NSE 115 may be specially designed to quickly and efficiently lookup data when given specific identifying information. For example, NSE 115 may be designed to quickly look up an IP address for a website when given the URL of that website.

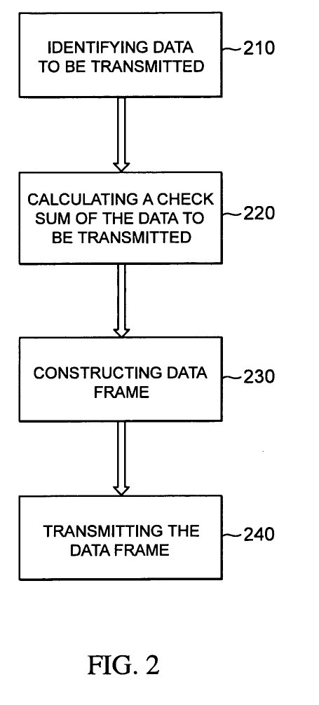

FIG. 2 shows an exemplary process of improving the efficiency of communication between components according to the present invention. As shown in FIG. 2, step 210 involves identifying the data to be transmitted to NSE 115 in a data frame. For example, if ASIC 105 has requested that NSE 115 resolve an IP address, ASIC 105 may identify the IP address as data to be communicated to NSE 115.

In step 220, a checksum, to be sent in each data frame 120, may be calculated for the data in the data frame. The checksum may serve the purpose of identifying errors in the transmitted data. In some embodiments, the checksum may enable correction of the detected errors. The checksum may be calculated by the transmitting component using a hash function, such as a cyclic redundancy check (“CRC”) function or a Hamming code. The length of the checksum may depend on the amount of data to be transmitted in each data frame 120. For example, a seven-bit CRC may provide sufficient error detection for 96 bits of transmitted data. In some embodiments, an eight, sixteen, or thirty-two bit CRC may be calculated. In some embodiments, the CRC may be more or less than eight-bits.

In step 230, the data frame to be transmitted may be constructed by the transmitting component. The data frame may include a start flag, a header field, a checksum, and one or more data packets containing the data that is to be transmitted. The start flag may be a sequence of bits to signal the transmission of a new frame. The header field may include information identifying one or more of, for example, the type of data in the data fields, the destination address of the component that is to receive the data frame, the priority of data frame, and the sending component. The data frame may be constructed so that the data fields will be aligned for the receiving component. For example, the data frame may be transmitted so that the data in the data frame is 32-bit aligned.

In step 240, the sending component transmits the data frame. For example, as shown in FIG. 1, ASIC 105 transmits data frame 120 to NSE 115 in step 240. Not all steps listed in the exemplary method of FIG. 2 need be performed in the order shown. For example, the data fields may be identified and the placed into data frame before the CRC is calculated. As a result, steps 220 and 230 may occur substantially simultaneously.

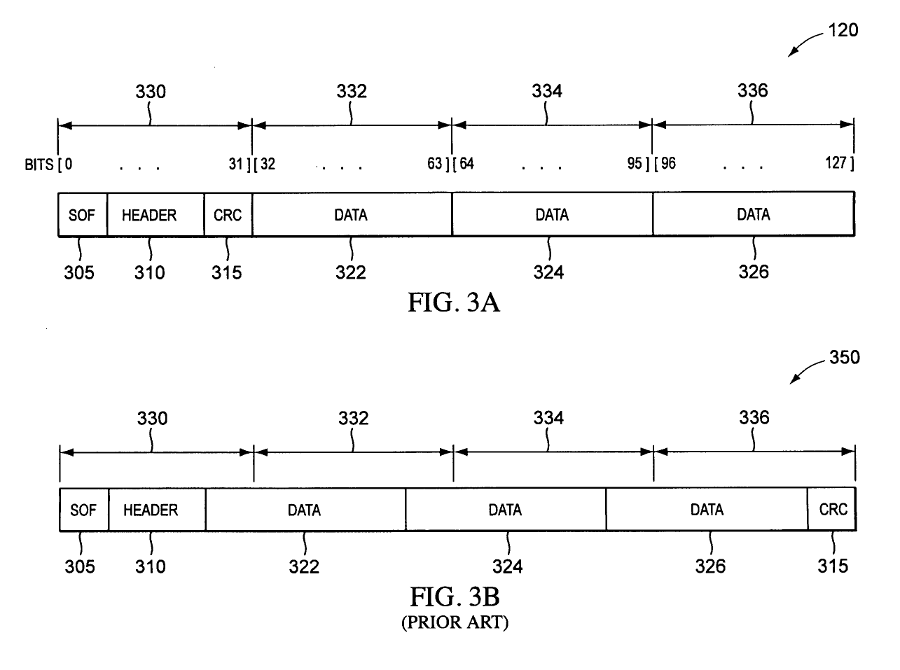

FIG. 3a illustrates an exemplary embodiment of a data frame that is constructed according to the invention. Each of lengths 330-336 shown in FIG. 3a may be 32-bits long. Exemplary data frame 120 includes start of frame field 305, header 310, CRC field 315, and data fields 322-326. As shown in FIG. 3a, header field 310 for data frame 120 may include information identifying NSE 115 as the component to receive data frame 120. The header field may include information identifying one or more of, for example, the type of data in the data fields, the priority of data frame 120, the destination address of the component that is to receive data frame 120, and the sending component. For example, header field 310 of data frame 120 in FIG. 3a may identify the contents of data fields 322-326 as a URL having high priority and being sent by ASIC 105.

Exemplary data frame 120 shown in FIG. 3a may include CRC field 315. In some embodiments, ASIC 105 may use a CRC function to calculate the checksum for the data to be included in data frame 120 and place the calculated checksum in CRC field 315. The checksum in CRC field 315 may be used to detect errors that may occur when transmitting data frame 120.

As depicted in FIG. 3a, exemplary data frame 120 may include data fields 322, 324, and 326. In the example in which ASIC 105 has been requested to resolve an IP address, the data for that request may be identified to be included in one or more of data fields 322, 324, and 326. In some embodiments, each of data frames 120 transmitted by ASIC 105 to NSE 115 may have the same number of data fields. As shown in FIG. 3a, each data frame 120 may contain three data fields; in some embodiments, each data frame 120 may include more or less than three data fields. Each of data frames 120 transmitted by ASIC 105 to NSE 115 may have the same number of data bits. As shown in FIG. 3a, the number of data bits in each data frame 120 may be 128 bits; in some embodiments, the number of data bits may be more or less than 128 bits of data.

Data frame 120 may be constructed so that data fields 322-326 may have a specific alignment. For example, data frame 120 may be constructed so that data fields 322, 324, and 326 may be 32-bit aligned, as shown in FIG. 3a. In the exemplary data frame 120 shown in FIG. 3a, checksum 315 has been placed in a position in data frame 120 so that it will be transmitted before the transmission of data fields 322-326. By moving checksum 315 to this position, the last 96 bits in data frame 120 include only data packets 322, 324, and 326. In this example, as seen in FIG. 3a, data fields 322-326 may be 32-bit aligned so that data field 326 is placed at the last 32 bit location 336 in data frame 120; data field 324 is placed at 32-bit location 334 in data frame 120; and data field 322 is placed at 32-bit location 332 in data frame 120.

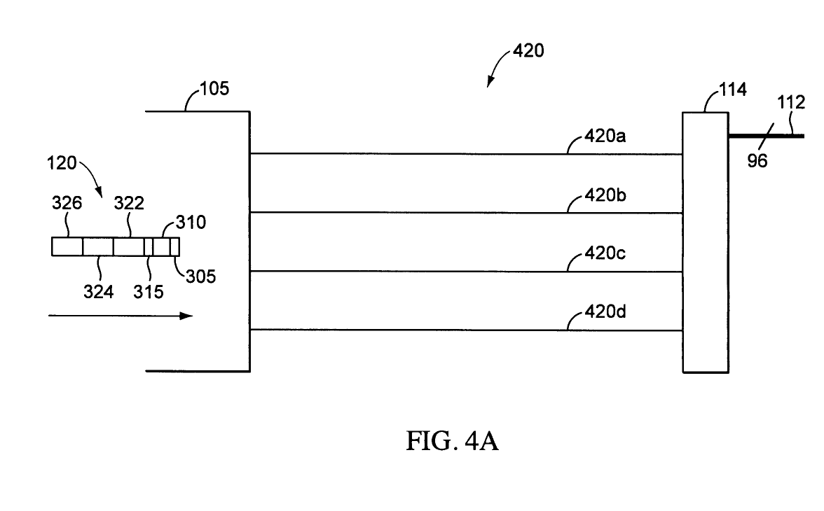

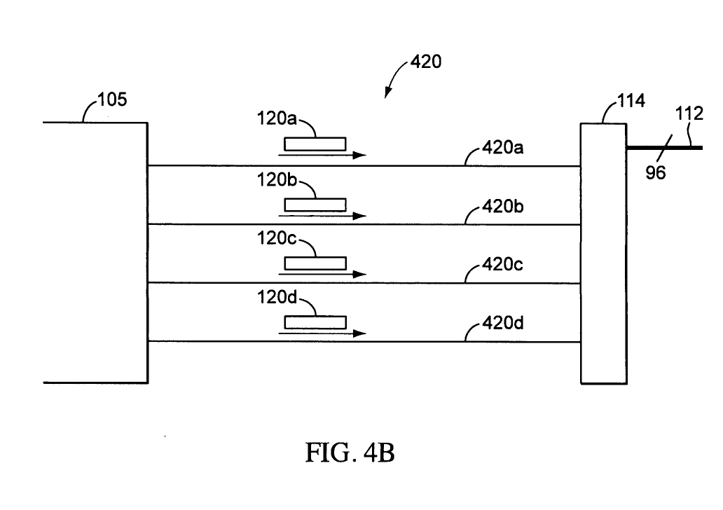

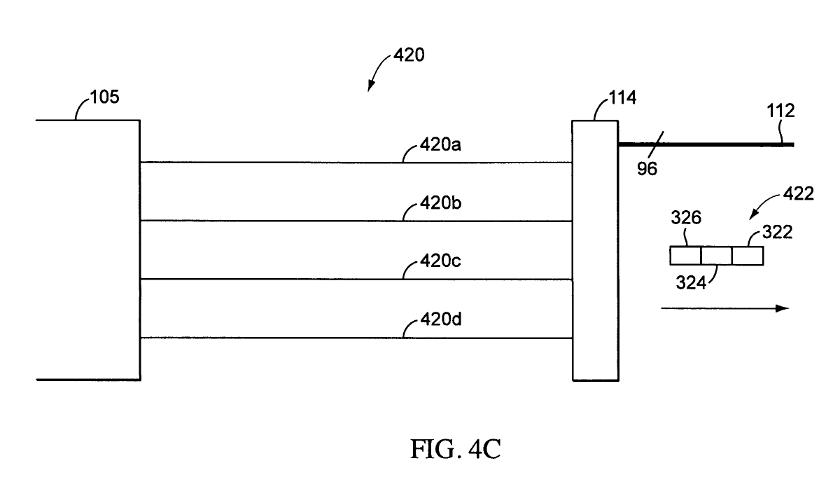

FIGS. 4a-c show an exemplary circuit that may benefit from transmitting aligned data. The exemplary circuit shown in FIG. 4a contains ASIC 105 coupled to shim 114 by serial connection 420, which includes serial data busses 420a-d. ASIC 105 is to transmit data frame 120 over serial connection 420 to shim 114, which may then convert the serial data into a form to be transmitted over parallel bus 112.

As shown in FIG. 4b, data frame 120 may be broken into four different packets to be transmitted over serial busses 420a-d. These four different packets are shown as data packets 120a-d, respectively. In some embodiments, data packets 120a-d may be constructed by striping the data contained in data frame 120. In some embodiments, data packets 120a-d may take sequential bits from data frame 120. For example, data packet 120a may contain data bits [0:31] of data frame 120; data packet 120b may contain data bits [32:63] of data frame 120; data packet 120c may contain data bits [64:95] of data frame 120; and data packet 120d may contain data bits [96:127] of data frame 120. In some embodiments, data packets 120a-d may divide the data bits of data frame 120 in a round robin fashion. For example, data packet 120a may contain bits 0, 4, 8, etc. of data frame 120; data packet 120b may contain bits 1, 5, 9, etc. of data frame 120; data packet 120c may contain bits 2, 6, 10, etc. of data frame 120; and data packet 120d may contain bits 3, 7, 11, etc. of data frame 120.

As shown in FIG. 4c, data packets 120a-d are received by shim 114, which converts the serial data transmitted in data packets 120a-d into parallel data packet 120e. Shim 114 transmits parallel data packet 120e over parallel bus 112. Parallel data packet 120e may contain data fields 322-326 from data frame 120. Data frame 120 was 32-bit aligned when transmitted from ASIC 105 so that data fields 322-326 occur at 32-bit locations 332-336. Because data fields 322-326 are 32 bit aligned, shim 114 will not need to use shift registers to shift the contents of data packets 120a-d when forming parallel packet 422. In some embodiments, the data contained in data fields 322-326 may include 80 bits of data and 16 bits of control information. In some embodiments, the data in data fields 322-326 may be arranged as a function of the pins of NSE 115.

FIG. 3b shows an example of a prior art data frame. Exemplary data frame 120 offers an advantage over prior art data frame 350 shown in FIG. 3b. As shown in FIG. 3b, data fields 322-326 will not be 32-bit aligned with lengths 332-336 even after removing start of frame 305 and Header 310. To be 32-bit aligned, the remaining fields of data frame 350—data fields 322-326 and CRC 315—may need to be processed by a component, such as a shift register, that can be used to shift the data in data fields 322-326 until data fields 322-326 are 32-bit aligned with 32-bit locations 332-336. In the process, CRC 315 will be removed from the 32-bit aligned data. Only after the data in data fields 322-326 of data frame 350 are shifted will data fields 322-326 align with 32-bit positions 332-336, respectively. The step of shifting the data in data fields 322-326, however, adds an extra processing step and requires extra processing time when compared to exemplary data frame 120.

The number of data fields included in data frame 120 may depend, at least partly, on the amount of time that is to pass between transmitting two successive data frames. In some embodiments, the transmitting device may begin to construct data frame 120 only after identifying all of the data that is to be placed into data frame 120. Further, the checksum may be calculated and placed into data frame 120 only after the transmitting device has placed all of the identified data into data frame 120. As more data is placed into data frame 120, the time needed to construct data frame 120 may increase. Accordingly, the latency of transmitting the packet may be a function of the time taken to calculate the checksum. In some embodiments, constructing a data frame having a large number of data fields or a large amount of data may result in an unacceptably high latency between determining the data to be transmitted in a data frame and actually transmitting the data frame. As a result, some embodiments of the present invention may limit the number of data fields or the amount of data in data frame 120 to reduce the latency in transmitting data frame 120.

In some embodiments of the invention, such as the exemplary embodiment in FIG. 1, ASIC 105 and NSE 115 may be connected to the same PCB, such as PCB 100. In some embodiments, ASIC 105 may be connected to one PCB while NSE 115 is connected to a different PCB located in the same device or in a difference device. ASIC 110 may be implemented using an ASIC, an integrated circuit, an FPGA, a field programmable object array, or a complex programmable logic device. In some embodiments, NSE 115 may be implemented using an ASIC, an NPU, a complex programmable logic device, or a field programmable object

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for transmitting a data frame from a first component to a second component, the second component having a data bus width for receiving data, the method comprising:
identifying a set of data packets containing data bits to be transmitted from the first component to the second component, the first component and the second component being connected to one printed circuit board;
calculating a check-sum as a function of the data bits in the data frame;
constructing the data frame to be transmitted, the data frame having at least one packet containing header data, at least one packet containing the check-sum, and the set of data packets containing data bits; and
transmitting the data frame to the second component such that the data bits in the set of data packets are correctly aligned to the data bus width of the second component.

2. The method of claim 1 wherein the step of calculating the checksum is performed using a hash function.

3. The method of claim 2, wherein the hash function is a Hamming code.

4. The method of claim 2 wherein the hash function is a cyclic redundancy check.

5. The method of claim 1, wherein at least one of the first component and the second component is a network search engine.

6. The method of claim 1 wherein at least one of the first component and the second component is at least one of an integrated circuit, a field programmable gate array, a complex programmable logic device, and a field programmable object array.

7. The method of claim 6 wherein the integrated circuit is an application specific integrated circuit.

8. The method of claim 1 wherein the step of transmitting the data frame occurs such that the checksum is positioned in the data frame adjacent to the packet containing header information.

9. The method of claim 1 wherein the step of transmitting the data frame occurs such that the checksum in the data frame is in a position in the data frame so that the checksum is transmitted by the first component at a time before the set of data packets in the data frame is transmitted by the first component.

10. The method of claim 1, wherein the set of data packets contains a number of data packets, the number of data packets in the set of data packets being a function of calculating the checksum.
